(19) United States
(12) Patent Application Publication
(10) Pub. No.: US 2014/0006504 A1
(43) Pub. Date: Jan. 2, 2014

(54) Apparatuses and Methods for Assessing User Interest Scores as Altered by Friends Influence

(71) Applicant: Jamie Jiménez, Helsinki (FI)

(72) Inventor: Jamie Jiménez, Helsinki (FI)

(73) Assignee: TELEFONAKTIEBOLAGET L M ERICSSON (PUBL), Stockholm (SE)

(21) Appl. No.: 13/574,392

(22) PCT Filed: Jun. 28, 2012
(86) PCT No.: PCT/IB12/53298

§ 371 Date: Aug. 8, 2012

(51) Int. Cl. G06F 15/16

(52) U.S. Cl. 709/204

(57) ABSTRACT

A node and method for storing/retrieving rating information about a node or a resource in a peer-to-peer (P2P) communication network. The method includes a step of requesting, at a first rating node, an identity of a storing node in which to store first rating information corresponding to a rated node or a rated resource, a step of adding the first rating information to a reputon, and a step of sending the reputon from the first rating node to the storing node to be stored.

### TECHNICAL FIELD

The present invention generally relates to systems, software and methods and, more particularly, to mechanisms and techniques for handling reputation information about a peer and/or a resource in a peer-to-peer (P2P) network.

### BACKGROUND

P2P networks are utilized today in various contexts, for example, for file sharing or voice-over-IP. The P2P networks are classified as structured and unstructured networks. Structured P2P networks employ a globally consistent protocol to ensure that any peer can efficiently route a search to another peer that has the desired file or service. To achieve this, a structured pattern of overlay links is employed. The most common type of structured P2P networks are DHT (Distributed Hash Table) based networks. An example of a P2P DHT network is Chord (see Stoica et al., “Chord: A Scalable Peer-to-peer Lookup Service for Internet Applications,” in Proceedings of the ACM SIGCOMM '01 Conference, San Diego, Calif., August 2001, pp. 149).

In the DHT, the information is stored among all the peers in the form of a hash table with several <key, value> pairs. When a peer in the overlay needs certain information, the peer has to perform a lookup of the key, and then to retrieve a value associated with the key if the key is stored in another peer.

However, these mechanisms are affected when a peer and/or a resource in the P2P network misbehaves, is faulty, or acts in unexpected ways. For this reason, reputation systems have been introduced to rate each peer and/or resource. Reputation systems for the Internet have existed for some time. They are used to rate anything from business transactions to social interactions. The reputation systems measure the “trustworthiness” of the peers and assess the safety of their interactions. For example, the Reputation Services Working Group has commenced the standardization on reputation reporting mechanisms in the Internet Engineering Task Force (IETF) as disclosed in Borenstein et al., “A Model for Reputation Reporting,” draft-ietf-repuute-model, Internet Draft (work in progress), 2012, available online at http://tools.ietf.org/html/draft-ietf-repute-model, and Borenstein and Kucherawy, “A Media Type for Reputation Interchange,” draft-ietf-repute-media-type, Internet Draft (work in progress), 2012, available online at http://tools.ietf.org/html/draft-ietf-repute-media-type.

The benefits of a standard reputation system are broader that just interoperability, because future technologies will benefit from common reputation systems. However, the working group of IETF has focused only on email content and HTTP interactions at this time.

It is noted that for the case of P2P systems, there are many publications that estimate the trustworthiness of peers, but there is no work toward standardizing the myriad of different metrics and algorithms used to estimate the trustworthiness of the peers and/or resources. Thus, there is a need for developing a mechanism that addresses the concept of how to report ratings in a standard fashion and independent of the communication network to which it is applied.

Accordingly, it would be desirable to provide devices, systems and methods that avoid the afore-described problems and drawbacks.

### SUMMARY

The possibility of having one or more faulty or malicious peers and/or resources in a P2P overlay network is likely. Thus, there is a need to have a rating mechanism that rates the peers and/or resources and a rating reporting mechanism that stores rating information about such faulty or malicious peer and/or resource and also accepts new rating information or provides the existing rating information to requesting peers. In one embodiment, the rating information is stored in a server or in the overlay such that other peers can access it. The rating information is standardized as will be described later and may be independent of the type of communication network.

According to one exemplary embodiment, there is a method for storing rating information about a node or a resource in a P2P communication network. The method includes a step of requesting, at a first rating node, an identity of a storing node in which to store first rating information corresponding to a rated node or a rated resource. The first rating information is added to a reputon and then the reputon is sent from the first rating node to the storing node to be stored. Various modifications of this method are discussed later.

According to another exemplary embodiment, there is a rating node in a P2P communication network for sending rating information about a rated node or a rated resource. The rating node includes an interface configured to request an identity of a storing node in which to store the rating information corresponding to the rated node or the rated resource, and a processor connected to the interface. The processor is configured to add the rating information to a reputon and then the interface sends the reputon from the rating node to the storing node to be stored.

According to still another exemplary embodiment, there is a method for retrieving rating information about a node or a resource in a P2P communication network. The method includes a step of requesting, from a lookup node, an identity of a storing node that stores a first reputon generated by a first rating node, a step of receiving the identity of the storing node, and a step of sending a request to the storing node to receive the first reputon.

According to another exemplary embodiment, there is a lookup node in a P2P communication network that requests rating information about a rated node or a rated resource. The lookup node includes an interface configured to request an identity of a storing node that stores a first reputon generated by a first rating node, receive the identity of the storing node, and send a request to the storing node to receive the first reputon. The lookup node also includes a processor connected to the interface and configured to extract the rating information from the first reputon.

Thus, it is an object to overcome some of the deficiencies discussed in the previous section and to provide a rating reporting mechanism applicable to various communication networks for storing and providing rating information about the peers and/or resources of the network. One or more of the independent claims advantageously provides such a reporting mechanism.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a P2P network;

FIG. 2 is a schematic diagram of a P2P network with rater nodes, a rated node and a storing node according to an exemplary embodiment;

FIG. 3 is a schematic diagram of a P2P network having a reputation server and a central authority server according to an exemplary embodiment;

FIG. 4 is a flow chart of a method for storing rating information in a P2P network according to an exemplary embodiment;

FIG. 5 is a flow chart of method for looking up rating information in a P2P network according to an exemplary embodiment; and

FIG. 6 is a schematic diagram of a node in a P2P network.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a P2P DHT network. However, the novel embodiments are not limited to this network, but may be applied to other types of networks.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment, there is a method for storing and/or retrieving reputation information from a server or a network. The method uses a reputon to transfer rating information between a rater node or a lookup node and a storing node. The storing node stores a rating score about a rated node. Any peer from the P2P network may have access to the rating score.

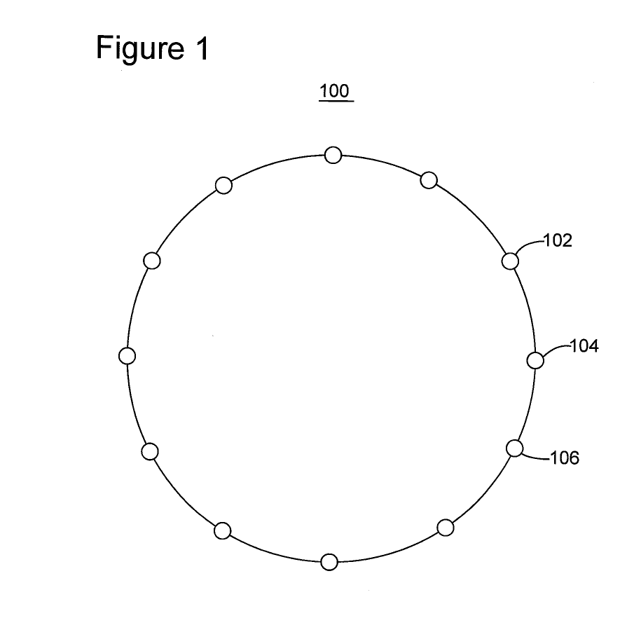

In an overlay network 100 as illustrated in FIG. 1, plural nodes (or peers) 102, 104, 106, etc. are connected and form a P2P communication network. Because node 102 is not directly connected to node 106, a signal from node 102 intended to be delivered to node 106 needs to arrive at node 104 and from here it is sent to node 106. One signaling mechanism that can achieve this result in a Chord-based protocol is Resource Location And Discovery (RELOAD).

RELOAD is a generic P2P signaling protocol that is currently being standardized in the Peer-to-Peer Session Initiation Protocol (P2PSIP) working group of the IETF. RELOAD uses the Chord Distributed Hash Table (DHT) algorithm as the default algorithm to organize participating nodes in a P2P overlay network. RELOAD provides a generic, self-organizing P2P overlay network service. Nodes can use the overlay to route messages to other nodes and to store and retrieve data. For simplicity, in the following, the novel rating reporting mechanism is introduced with reference to RELOAD. However, it is noted that the novel mechanism is applicable to other signaling protocols.

Further, the novel mechanism uses the idea of reputon. A reputon may be defined as a single, independent, object that includes reputation information. Thus, a particular query about a peer or resource will receive one or more reputons in response, depending on the nature of the data collected and reported by the server or other peers. Using reputons to store reputation information is helpful for assessing qualitative properties of the nodes such as churn, availability, etc. in a quantitative manner. Thus, the novel mechanism may be a complement or even a substitute for other security mechanisms such as certification. In addition, the novel mechanism may provide resilience to different types of attacks, e.g., denial of service, file poisoning, Eclipse (it is an attack in which the attacker controls many nodes of the P2P network and can, virtually, separate the P2P network into subnets) and Sybil attacks and also resilience to malfunction, e.g., high churn, high latency, etc.

Reputons may be defined by a Key and a Value and can be expressed in JavaScript Object Notation. Some fields of a reputon may be rater (a node that rates another node), assertion, rated (a node being rated) and rating (a score). Optional fields may include confidence, rater-authenticity, sample-size and updated. When using reputons in RELOAD, the uniform resource identifier (URI) used to assign a rater node and a rated node can depend on the usage e.g., session initiation protocol (SIP), Extensible Messaging and Presence Protocol (XMPP), Constrained Application Protocol (CoAP), Simple Network Management Protocol (SNMP), etc. The rated and rater can also use an Augmented Backus-Naur Form (ABNF) syntax in the form of RELOAD URIs. These are some examples of protocols that may be used with the novel reputation mechanism. Those skilled in the art would recognize that the novel features equally apply to other mechanisms. For simplicity, in the following, the NodeIDs are used as an identifier for the nodes as the NodeIDs are the natural identifier for RELOAD nodes and resources.

The assertion field may be defined by an application parameter. For example, in the following, the reload_security application and the reload resource application are associated with one or more assertions as explained later in this document.

Rating is the overall rating score for a given peer, expressed as a floating-point number between 0.0 and 1.0, including 0.0 and 1.0. Those skilled in the art would recognize that other ranges may be used for the rating. The rating is calculated based on any known rating mechanism. No rating mechanism is described herein as this is beyond the scope of this application.

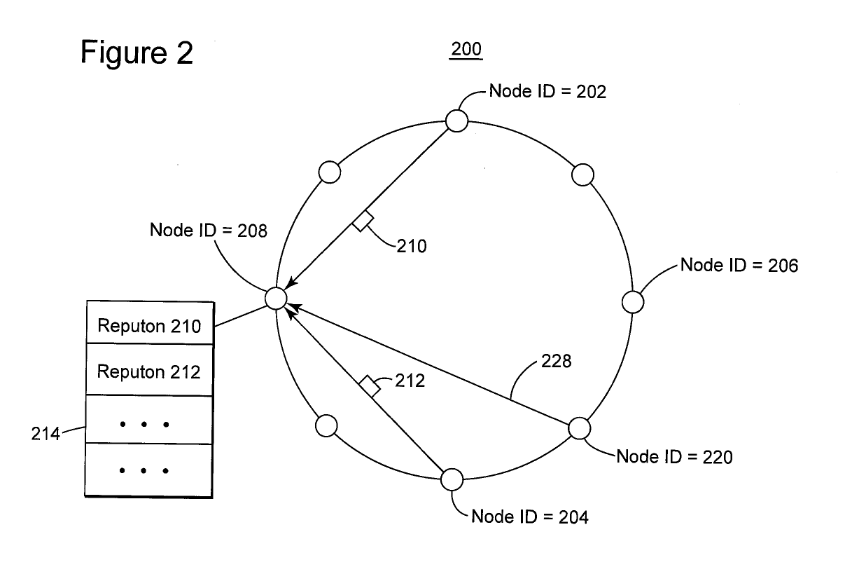

Next, the novel reputation reporting mechanism is discussed with regard to FIG. 2. Initially, the process of addressing the reputons is discussed, followed by the process of storing reputons and the process of accessing reputons.

FIG. 2 illustrates a network 200 that includes plural nodes. For illustrating the novel reputation reporting mechanism, a first rating node 202, a second rating node 204, a rated node 206 and a storing node 208 are considered. At least one of the first and second rating nodes 202 and 204 have used a rating mechanism and rated the rated node 206. Having the rating score, these nodes need to store this information in the communication network so that other nodes may use it. Before being able to store the information, a node needs a mechanism to address reputons in Reload.

As noted above, within the same Overlay, the NodeIDs are used to identify the peers/resources that are rating and being rated. Individual reputons are stored in the Reload overlay under a key, for example, Resource-ID, that is calculated by using a hash algorithm. The hash algorithm may be a cryptographic hash algorithm. In one application, the hash algorithm is a secure hash algorithm (SHA-1). Thus, the following command may be used to address the reputon:

hash(“repute:<nodeID_of rater>:<ID_of_rated>”).

An identifier of the rated information can be either a NodeID, when rating a node, or a ResourceID, when rating a resource. If a Reload dictionary is used to store several ratings from different rating nodes (for a same rated node), the following command may be used to address the reputon:

hash(“repute:<nodeID_of_rated>”).

Having in place a mechanism for addressing one or more reputons, next it is discussed how to store the rating information. As already noted above, the rating information may be stored either in a central server or in the overlay itself. If a central server is chosen, the Reload contemplates the use of a central enrollment server to assign NodeIDs to the various nodes. Further, the Reload contemplates a Central Authentication Server to assign certificates to the various nodes. Thus, it is possible to store the reputons in the central trust server.

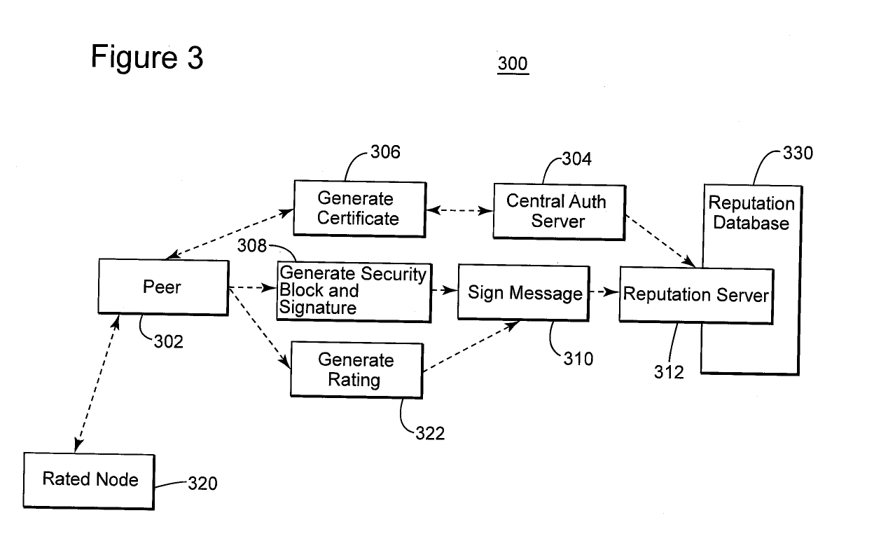

In that scenario and as shown in FIG. 3, the novel mechanism may use the Reload's public-key infrastructure (PKI) system to ensure the authenticity of the storing/rater peer. FIG. 3 shows such a system 300 having a peer 302 that interacts with a central authority server 304 to generate a certificate 306. The peer 302 sends its public key or certificate to the central authentication server 304 in case it does not have one already assigned. Then, the peer 302 uses its private key to generate a signature 308 and sends a signed message 310 to a reputation server 312. After establishing a connection with the reputation server 312, the peer 302 may rate a rated node 320 through an existing process. Having the rating information at 322, a reputon is sent to the reputation server 312 and the reputation server stores this information in a reputation database 330.

In case that a distributed solution is preferred, the rating information is stored in the overlay as discussed next. For storing an individual reputon, an opaque Reputon value (similar to C++ opaque pointer) may be used. Alternatively, a Reload structure, named Reputon, may be used. An example of an opaque Reputon is:

struct {
opaque reputon[length];
} Op_Reputon;

The reputon may include a structure as follows:

struct {
NodeID rater
NodeID rating
opaque assertion;
uint32 rating;
/*extensions*/
} Reputon;

The reputon includes an identity of the rater node (i.e., the node that is rating another node or resource), an identity of the rated node (i.e., the node that is being rated), an Assertion that needs to be estimated (various examples of Assertions are discussed later) and the rating score (i.e., a number).

The reputon may include other fields (to be added in the /*extensions*/part of the structure), as for example, a confidence value (e.g., a floating-point number between 0.0 and 1.0) for expressing how accurate is the rating score given by the rater node to the rated node, a rating time that is a time-stamp indicating when the rater node has rated the rated node (e.g., the number of seconds since a predefined date), etc. It is noted that other fields may be added and the examples provided above for the reputon are not exclusive.

The novel mechanism also allows storing plural reputons. For example, multiple nodes can rate a same rated node and store their rating information to the same ResourceID. This feature allows for storing the reputon information from many rater nodes at the same node (a storing node), thus obtaining the general opinion on one node from the rest of the overlay. An exemplary structure for such a dictionary reputon is:

struct {
NodeID rater;
Opaque Reload_Reputon[length];
} Dictionary_Reputon;

This mechanism is illustrated in FIG. 2 as discussed next. The first rater node 202 intends to rate the rated node 206. Also, the second rater node 204 intends to rate the rated node 206. Thus, each of the first and second rater nodes 202 and 204 uses a hash algorithm (for example, a cryptographic hash algorithm or a secure hash algorithm) for determining which storing node would store the rating information for the rated node 206. In other words, the first and second rater nodes 202 and 204 may use the function h(“repute:206”)=208 for determining that the storing node is 208 for the rated node 206.

The rating information (which was already determined based on known algorithms) determined by the first rater node 202 is added to a first reputon 210 and the rating information determined by the second rater node 204 is added to a second reputon 212. The first and second reputons 210 and 212 are sent to the storing node 208 to be stored. Thus, the first and second rater nodes 202 and 204 may send the rating information by invoking, for example, a command:

StoreRequest (ResourceID = 208, Rater NodeID=202 or 204,

Rated NodeID=206 S_value),

where S_value is the rating information determined by the nodes 202 or 204 for the node 206. The first and second reputons 210 and 212 or their information may be stored in a reputon dictionary 214 as also illustrated in FIG. 2. The reputon dictionary 214 may include the following fields:

NodeId = 202
Stored Value =

202 (rater node)
206 (rated node)
churn (assertion)
0.5 (rating)
0.9 (confidence)
X (other parameters);

NodeId = 204
Stored Value =

204 (rater node)
206 (rated node)
Churn (assertion)
0.5 (rating)
0.9 (confidence)
Y (other parameters).

With regard to the same figure, a reputon lookup process is now described. Consider that a lookup node 220 wishes to retrieve the reputation information given by node 202 to the rated node 206. First, the lookup node 220 needs to determine which node in the network stores that information. Thus, the lookup node 220 may lookup for this information by using a hash function h(“repute202:206)=208. The result 208 of this function tells the lookup node 220 that node 208 stores the reputation information about rated node 206. Then, the lookup node 220 performs a lookup 228 in the DHT that provides the following result:

Resource-ID = h(“repute:202:206”)
KEY = 208
VALUE =
LATENCY;
1.0;
0.2;
1335201927.

This means that node 202 found that the latency of node 206 is too high (1.0) but node 202 is not very confident (0.2) of the result. This could be due to few samples being taken. If the system had previously stored more reputation information, a lookup for series of reputons would show:

Resource-ID = h(“repute:206”)
KEY = 202
VALUE =

202; [it is noted that this value of 202 is repeated

because the first occurrence represents a dictionary key
and the second occurrence represents the rating node. In
other words, if the rating node is also the storing node this
double occurrence of the 202 value happens]

CHURN;
206;
0.5;
0.9;
1335207937;

KEY = 204
VALUE =

204;
CHURN;
206;
0.99;
1.0;
1335207976.

This particular result indicates that node 206 has been rated by nodes 202 and 204 and both have found some churn problems as the rating score for churn is high, 0.5 and 0.99, both rater nodes have high confidence in these results. In one embodiment, if a query for a particular node does not produce any information, it suggests that such a node is operating normally. It is noted that the structure of the reputon may vary from the above-noted examples, and those skilled in the art would recognize that these variations are within the scope envisioned by the exemplary embodiments. For example, the reputon may be configured to include more assertions (e.g., churn, latency, etc.).

The assertions may refer to node security assertions and/or resource assertions. These assertions are novel because the existing algorithms are focused on email parameters and http parameters. The node security assertions may be implemented in a reload_security application that can be used by any Reload peer. Thus, this application estimates/evaluates various properties or characteristics of a peer (or node). Requirements on P2PSIP present different security issues, e.g., often a peer may be malfunctioning, but not misbehaving. Based on current security issues (e.g., Chopra et al., “Peer-to-peer overlays for Real-Time Communication: Security Issues and Solutions” in Communications Surveys & Tutorials, 2009, vol. 11, issue 1, pages 4-12, IEEE and Schulzrinne et al., “Security Issues and Solutions in Peer-to-peer overlays for Real-Time Communications”, 2010, Internet Research Task Force, http://tools.ieff.org/html/rfc5765), a Reload reputation application can be configured to recognize at least one of the following assertions:

CONSUMPTION: P2PSIP peers should store a limited amount of contact information. Thus, this assertion is related to storing too much information.

UNAVAILABLE: P2PSIP peers should be available while they are part of the overlay in order to route or store information (unless it is a Client node). A peer that is unavailable at times or leaves the overlay ungracefully creates lookup, storage and general malfunction of the network. Thus, this assertion provides information regarding the unavailability of the node or peer.

CORRUPTION: P2PSIP peers should not store malformed information or send malformed messages. If the integrity of the peer is not preserved, that could mean that a peer is trying to impersonate another peer. Thus, this assertion is associated with the level of file corruption.

LATENCY: P2PSIP peers should have good connectivity in order to be full overlay peers (not clients). A peer with very high latency could be considered malicious because this peer decreases the overall performance of the overlay. Thus, this assertion is associated with the amount of latency present at the peer.

CHURN: P2PSIP peers should be available for some periods of time. If a peer leaves and joins the network frequently, that could be considered malicious behavior because it increases the load on the other peers. Thus, this assertion is associated with having high churn rates.

Other types of malicious behavior or malfunction can be specified in a similar manner as the previous five assertions. As previously noted, a reputon can include one or more of these assertions.

Regarding the resource assertions, they may be implemented in a reload_resource application that can be used in any structured P2P network, not just a Chord based network.

Basic requirements on resources stored in a network are seen from the point of view of a node performing a retrieval. The reload_resource application does not rate the node storing the resource or network-related issues. The reload_resource application rates the problems that may arise regarding the availability and quality of a resource, when trying to obtain resources from a DHT, as well as false positives and misplaced resources.

Thus, a reputation application should recognize at least one of the following assertions:

UNAVAILABLE: Peers should be able to retrieve a resource from another peer. If the resource is not located at its assigned ReourceID, then the resource is unavailable. Thus, this assertion is related to whether the resource is available or not.

CORRUPTION: A resource stored in a ResourceID should be readable by the retrieving peer. However, there are cases when the resource is not readable. Thus, this assertion is associated with file corruption.

QUALITY: At times, a resource is available and delivers the content appropriately but, for example, with low quality (video, audio). Thus, this assertion is related to the quality of various parameters associated with the resource.

Other types of malicious behavior or malfunction of the resource can be specified in a similar manner as the previous assertions. Thus, the reload_resource application can include one or more of the above-noted resources but also additional resources.

One or more of the exemplary embodiments discussed above defines a reputation reporting mechanism for distributed systems. The embodiments were discussed with reference to RELOAD. However, other signaling protocols may be used to implement the reputation reporting mechanism.

According to at least one embodiment, the novel mechanism may be used for providing a distributed rating service for individual peer-to-peer nodes. Another embodiment may be used in the detection of malfunctioning or malicious peers.

One or more embodiments enables quick retrieval of the ratings made by a rater node about a rated node or resource, integrating transparently the retrieval with the traditional RELOAD behavior. One embodiment uses the Dictionary mode in RELOAD in order to store multiple ratings of one rated node made by several rater nodes. In one embodiment, the novel mechanism does not modify the way RELOAD already operates (lookup, routing and storage), i.e., implements the rating reporting mechanism based on the existing commands in RELOAD.

The novel reputation reporting mechanism is compatible with any other quantitative mechanism used in P2P networks, because the basic concept of such mechanism is to rate a node/resource.

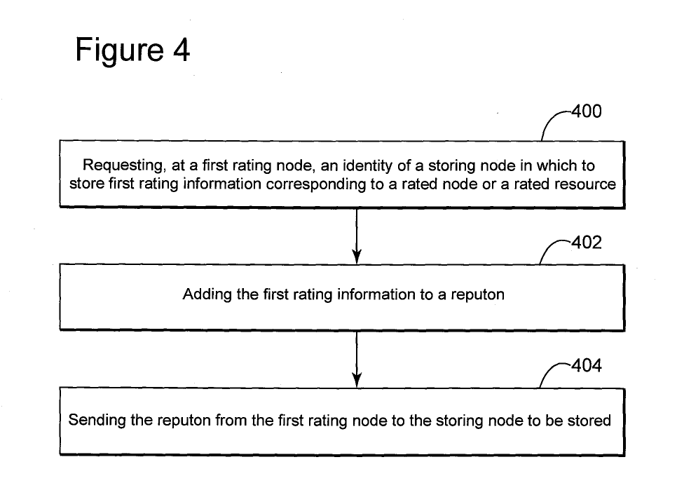

The novel mechanism discussed above may be implemented as a method, as illustrated in FIG. 4, either in the network or in a node or a server as discussed next. The method includes a step 400 of requesting, at a first rating node, an identity of a storing node in which to store first rating information corresponding to a rated node or a rated resource; a step 402 of adding the first rating information to a reputon; and a step 404 of sending the reputon from the first rating node to the storing node to be stored.

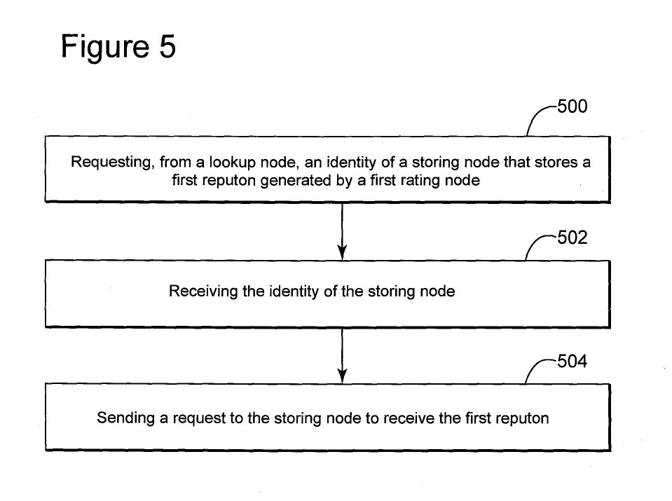

The mechanism may also be implemented as a method for retrieving rating information about a node or a resource in a peer-to-peer (P2P) communication network. The method includes, as illustrated in FIG. 5, a step 500 of requesting, from a lookup node, an identity of a storing node that stores a first reputon generated by a first rating node; a step 502 of receiving the identity of the storing node; and a step 504 of sending a request to the storing node to receive the first reputon.

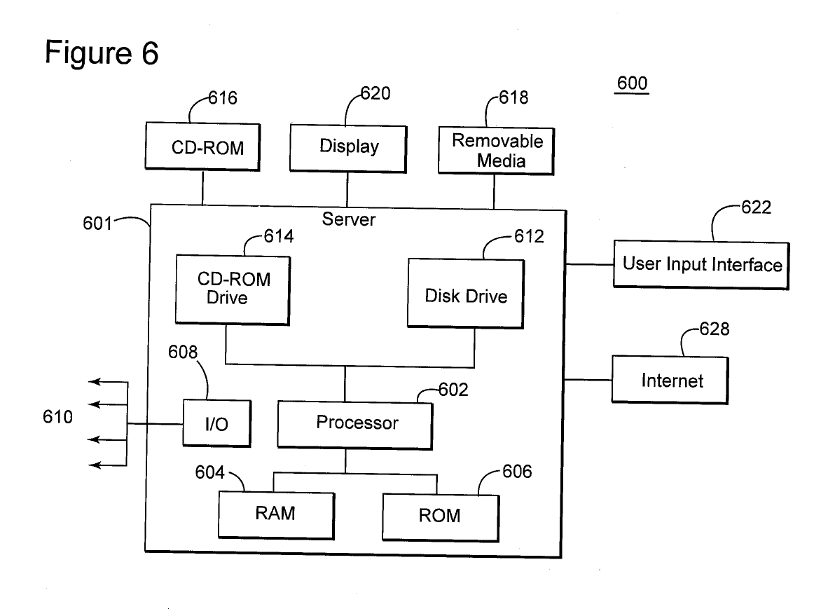

For purposes of illustration and not of limitation, an example of a representative node (peer) capable of carrying out operations in accordance with the exemplary embodiments is illustrated in FIG. 6. Hardware, firmware, software or a combination thereof may be used to perform the various steps and operations described herein.

The exemplary node 600 suitable for performing the activities described in the exemplary embodiments may include or not a server 601. Such a server 601 may include a central processor (CPU) 602 coupled to a random access memory (RAM) 604 and to a read-only memory (ROM) 606. The ROM 606 may also be other types of storage media to store programs, such as programmable ROM (PROM), erasable PROM (EPROM), etc. The processor 602 may communicate with other internal and external components through input/output (I/O) circuitry 608 and bussing 610, to provide control signals and the like. The processor 602 carries out a variety of functions as is known in the art, as dictated by software and/or firmware instructions.

The server 601 may also include one or more data storage devices, including hard drives 612, CD-ROM drives 614, and other hardware capable of reading and/or storing information such as DVD, etc. In one embodiment, software for carrying out the above discussed steps may be stored and distributed on a CD-ROM 616, removable media 618 or other form of media capable of portably storing information. These storage media may be inserted into, and read by, devices such as the CD-ROM drive 614, the disk drive 612, etc. The server 601 may be coupled to a display 620, which may be any type of known display or presentation screen, such as LCD, LED, plasma display, cathode ray tubes (CRT), etc. A user input interface 622 is provided, including one or more user interface mechanisms such as a mouse, keyboard, microphone, touch pad, touch screen, voice-recognition system, etc.

The server 601 may be coupled to other computing devices, such as the landline and/or wireless terminals, via a network. The server may be part of a larger network configuration as in a global area network (GAN) such as the Internet 628, which allows ultimate connection to the various landline and/or mobile client/watcher devices.

The disclosed exemplary embodiments provide a node, a method and a computer program product for reporting reputation information in a P2P network. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for storing rating information about a node or a resource in a peer-to-peer (P2P) communication network, the method comprising:
requesting, at a first rating node, an identity of a storing node in which to store first rating information corresponding to a rated node or a rated resource;
adding the first rating information to a reputon; and
sending the reputon from the first rating node to the storing node to be stored.

2. The method of claim 1, wherein the reputon is a data structure that includes at least one of an identity of the first rating node, an identity of the rated node or the rated resource, an assertion, and a rating score.

3. The method of claim 2, wherein the identity of the first rating node is a node identification used in an overlay of the P2P network.

4. The method of claim 2, wherein the assertion is related to one or more characteristics of a node of the communication network and the characteristics include at least one of consumption, unavailability, corruption, latency, and churn.

5. The method of claim 4, wherein consumption is related to storing a limited amount of contact information, unavailability is related to an amount of time a node is available in the communication network, corruption is related to storing or sending malformed information, latency is related to a connectivity of a node in the communication network, and churn is related to a frequency of joining and/or leaving the communication network.

6. The method of claim 2, wherein the assertion is related to one or more characteristics of a resource available in the communication network and the characteristics include at least one of unavailability, corruption, and quality.

7. The method of claim 6, wherein unavailability describes whether or not the resource is available to a node in the communication network, corruption describes whether or not the resource is readable by the node in the communication network, and quality describes whether or not the resource delivers its content with an expected quality parameter.

8. The method of claim 2, wherein the rating score is a number.

9. The method of claim 1, wherein the step of requesting comprises:
using a hash algorithm for obtaining the identity of the storing node.

10. The method of claim 1, wherein the storing node is a server of the P2P communication network.

11. The method of claim 1, wherein the communication network uses a Resource Location And Discovery (RELOAD) signaling protocol and the reputon is implemented in the RELOAD.

12. The method of claim 1, further comprising:
requesting, at a second rating node the identity of the storing node in which to store second rating information corresponding to the rated node or the rated resource;
sending another reputon from the second rating node to the storing node; and
storing the another reputon at the storing node.

13. The method of claim 12, wherein the storing node is configured to store the first reputon and the second reputon in a reputon dictionary.

14. The method of claim 1, further comprising:
requesting, from a lookup node, the identity of the storing node that stores the first reputon generated by the first rating node; and
sending a request to the storing node to receive the first reputon.

15. The method of claim 1, further comprising:
requesting, from a lookup node, the identity of the storing node that stores first and second reputons generated by various rating nodes; and
sending a request to the storing node to receive the first and second reputons.

16. A rater node in a peer-to-peer (P2P) communication network for sending rating information about a rated node or a rated resource, the rater node comprising:
an interface configured to request an identity of a storing node in which to store the rating information corresponding to the rated node or the rated resource; and
a processor connected to the interface and configured to add the rating information to a reputon,
wherein the interface further sends the reputon from the rater node to the storing node to be stored.

17. A method for retrieving rating information about a node or a resource in a peer-to-peer (P2P) communication network, the method comprising:
requesting, from a lookup node, an identity of a storing node that stores a first reputon generated by a first rating node;
receiving the identity of the storing node; and
sending a request to the storing node to receive the first reputon.

18. The method of claim 17, further comprising:
receiving the first reputon; and
extracting the rating information from the first reputon.

19. The method of claim 17, further comprising:
sending a request to the storing node to receive plural reputons.

20. The method of claim 17, wherein the reputon is a data structure that includes at least one of an identity of the first rating node, an identity of the rated node or the rated resource, an assertion, and a rating score.

21. The method of claim 20, wherein the assertion is related to one or more characteristics of a node of the communication network and the characteristics include at least one of consumption, unavailability, corruption, latency, and churn.

22. The method of claim 20, wherein the assertion is related to one or more characteristics of a resource available in the communication network and the characteristics include at least one of unavailability, corruption, and quality.

23. The method of claim 17, wherein the storing node is a server of the P2P communication network.

24. A lookup node in a peer-to-peer (P2P) communication network for requesting rating information about a rated node or a rated resource, the lookup node comprising:
an interface configured to
request an identity of a storing node that stores a first reputon generated by a first rating node,
receive the identity of the storing node, and
send a request to the storing node to receive the first reputon; and
a processor connected to the interface and configured to extract the rating information from the first reputon.
